(19) United States
(12) Patent Application Publication
(10) Pub. No.: US 2014/0115064 A1
(43) Pub. Date: Apr. 24, 2014

(54) COLLABORATION HUB

(71) Applicant: BANK OF AMERICA CORPORATION, Charlotte, NC (US)

(72) Inventors: Matthew A. Calman, Charlotte, NC (US); Carrie A. Hanson, Charlotte, NC (US); John M. Rees, Charlotte, NC (US); Nancy G. Talarico, Matthews, NC (US)

(73) Assignee: Bank of America Corporation, Charlotte, NC (US)

(21) Appl. No.: 13/655,749

(22) Filed: Oct. 19, 2012

(51) Int. Cl. G06F 15/16

(52) U.S. Cl. 709/205

(57) ABSTRACT

According to one embodiment, an apparatus may store a document associated with a user. The apparatus may further receive a transaction associated with the user and associate the document with the transaction. The apparatus may then initiate a communication session associated with the transaction between the user and a participant. The apparatus may assign a task to the participant so that the participant is responsible for performing the task in order for the transaction to be resolved.

### TECHNICAL FIELD

This disclosure relates generally to an apparatus that allows for asynchronous communication.

### BACKGROUND

The processing of complicated transactions often involves the participation of several parties and voluminous amounts of paperwork kept by each party thereby increasing demand for electronic storage and network bandwidth. Parties may also encounter challenges synchronizing calendars and schedules in order to complete the processing of the transaction.

### SUMMARY OF THE DISCLOSURE

According to one embodiment, an apparatus may store a document associated with a user. The apparatus may further receive a transaction associated with the user and associate the document with the transaction. The apparatus may then initiate a communication session associated with the transaction between the user and a participant. The apparatus may assign a task to the participant so that the participant is responsible for performing the task in order for the transaction to be resolved.

According to another embodiment, one or more computer-readable non-transitory storage media may embody software that is operable when executed to present, on a display, a transaction associated with a user, a document associated with the transaction, and a plurality of contacts. The software may further communicate a request to invite a contact to participate in a communication session. The software may also initiate the creation of a task associated with the transaction and communicate a request to assign the task to the contact so that the contact is responsible for performing the task in order for the transaction to be resolved.

Certain embodiments may provide one or more technical advantages. A technical advantage of one embodiment includes reducing the demand on electronic storage. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a system that allows for asynchronous communication;

FIG. 2 illustrates a device of the system of FIG. 1 that aids in asynchronous communication;

FIG. 3 illustrates a device of the system of FIG. 1 that aids in asynchronous communication;

FIG. 4 is a flowchart illustrating a method of asynchronous communication.

### DETAILED DESCRIPTION

This disclosure describes a system for asynchronous communication. The system may be used to help in the processing of complex transactions involving multiple parties and numerous documents by providing an interface through which multiple parties may communicate and/or collaborate. In this manner, the system may reduce the storage constraints on each individual party and increase the speed at which the transaction is processed, while also increasing efficiency through a shared communications stream to avoid repetition and multiple copies of documents and comments.

For example, a user may be planning his estate. This process may involve the user having to prepare several documents including a will, a power of attorney, and/or a medical power of attorney. Furthermore, the user may need to prepare trusts, life insurance, and/or annuities. In order to make these preparations, the user may need to speak with attorneys, bankers, insurance agencies, and/or potential trustees. Each one of these parties may need to retain several documents that pertain to the user, and the user may need to speak to each party separately in order to enact any changes in these documents. For example, if the user decides to add his spouse as a joint owner on his home, then the user may need to speak with an attorney to change an existing will and to a banker to change an existing mortgage on the home.

The user may use the system to help process the addition of his spouse as a joint owner on the home. The system may store all the documents that relate to this process such as the will and mortgage documents. Furthermore, the system may maintain a list of contacts that relate to this process such as contacts for the attorney and the banker. The user may then use the system to communicate and to view and edit documents with the attorney and the banker. The system may allow the user, the attorney, and the banker to chat with each other during a communication session. The system may also allow the user, attorney, and banker to view and edit any pertinent documents during the communication session. In this manner, the user, the attorney, and the banker may edit important documents by interacting through one interface.

As another example, the user may wish to purchase a home. In order to process the purchase, the user may need to communicate with an agent, a broker, and a lender. Each party may also need to fill out different documents, such as a purchase agreement and a loan agreement in order to process the purchase.

The user may use the system to quickly process the purchase. For example, the system may allow the user to communicate with the agent, the broker, and/or the lender during a communication session. The system may also store all documents relevant to the purchase. The user, agent, broker, and lender may then view and edit these documents as appropriate at a later time. In this manner, storage constraints on each party may be reduced because all documents relevant to the purchase are stored in system 100. Furthermore, the system may allow faster processing of the purchase by allowing multiple parties to collaborate synchronously. As well, the system may allow for more efficient processing by avoiding repetition or copying of information by allowing for asynchronous accumulation, storage, and access.

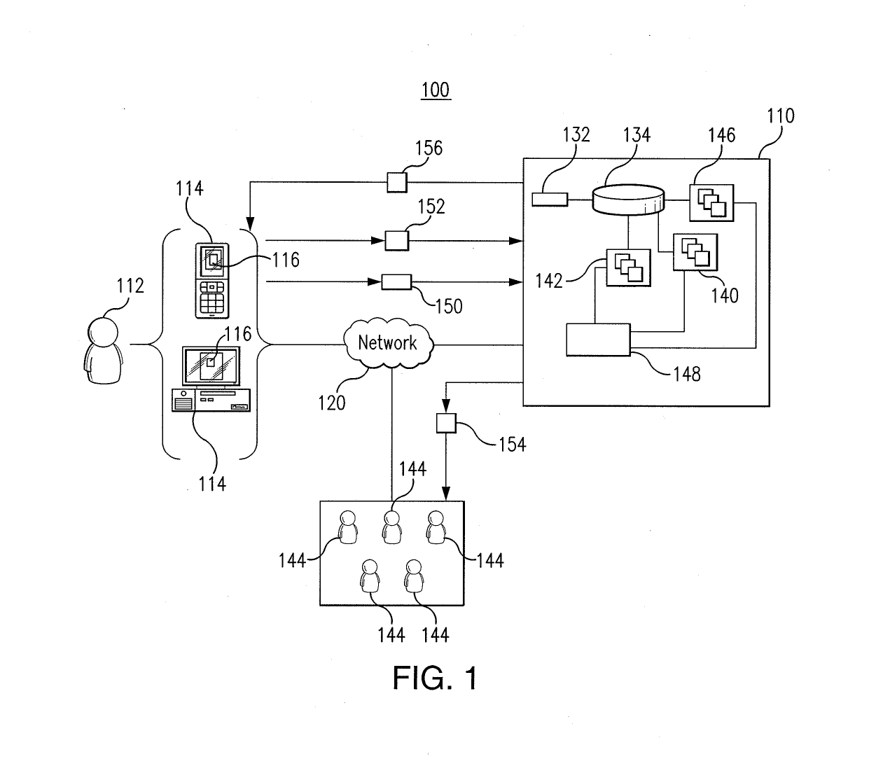

FIG. 1 illustrates a system 100 that allows for asynchronous communication. As provided by FIG. 1, system 100 may include a device 114 and a server 110. Device 114 may be communicatively coupled to server 110 through network 120. In particular embodiments, system 100 may aid user 112 by providing an interface through which user 112 may quickly process complex transactions. The system 100 may store documents 140 relevant to the transaction and the system 100 may store contacts 142 with which the user 112 may communicate. Furthermore, the system 100 may store tasks 146 that may be completed during the processing of the transaction. The user 112 may invite participants 144 associated with contacts 142 to participate in a communication session, and during that communication session the user 112 and the participants 144 may view and edit documents 140 and assign and complete tasks 146.

User 112 may use device 114 to interact with system 100. Device 114 may be associated with user 112. For example, device 114 may be user's 112 cell phone, table, personal computer, and/or laptop. In particular embodiments, user 112 may use device 114 to interact with server 110 and participants 144 in order to process a transaction. For example, user 112 may use device 114 to chat with participants 144 and to access documents 140 stored on server 110. Participants 144 may also be associated with devices 114 that execute application 116 to perform the functions described herein.

Device 114 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 100. Device 114 may also include a user interface, such as a display, a touchscreen, a microphone, keypad, or other appropriate terminal equipment usable by user 112.

Device 114 may execute an application 116. In particular embodiments, device 114 may include a memory and a processor operable to store and to execute application 116. Device 114 may execute application 116 to perform the functions described herein. For example, when executed, application 116 may present on a display of device 114 an interface through which user 112 may communicate with participants 144 and access documents 140 stored on server 110.

Device 114 may be communicatively coupled to network 120. Network 120 may be configured to route network traffic to and from device 114 and server 110. This disclosure contemplates any suitable network 120 operable to facilitate communication between the components of system 100. Network 120 may include any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Server 110 may be communicatively coupled to network 120. Server 110 may aid user 112 in the processing of transactions. For example, server 110 may provide a communication session 148 that allows user 112 to interact with participants 144 in order to assign and complete tasks 146 associated with the transaction.

Server 110 may include a memory 144 and a processor 132 communicatively coupled to the memory 134 that perform the functions described herein. Memory 134 may perform the storage functions of server 110. For example, memory 134 may store documents 140, contacts 142, and/or tasks 146. Processor 132 may perform the communication and/or determining functions of server 110. For example, processor 132 may communicate messages and invitations to other elements of system 100. Furthermore, processor 132 may examine received messages to determine the next step to be performed by server 110.

Memory 134 may store, either permanently or temporarily, data, operational software, or other information for processor 132. Memory 134 may include any one or a combination of volatile or non-volatile local or remote devices suitable for storing information. For example, memory 134 may include random access memory (RAM), read only memory (ROM), magnetic storage devices, optical storage devices, or any other suitable information storage device or a combination of these devices.

Processor 132 may control the operation and administration of server 110 by processing information received from network 120 and memory 134. Processor 132 may include any hardware and/or software that operates to control and process information. Processor 132 may be a programmable logic device, a microcontroller, a microprocessor, any suitable processing device, or any suitable combination of the preceding.

Server 110 may allow user 112 to interact with participants 144 to process a transaction. User 112 may use device 114 to communicate a transaction to server 110. In particular embodiments, server 110 may authenticate user 112 prior to processing the communicated transaction. For example, user 112 may provide a username and/or password to server 110 in order to authenticate user 112. Server 110 may use the username and/or password to authenticate user 112.

Server 110 may initiate a communication session 148 to help user 112 process the communicated transaction. User 112 may invite participants 144 to participate in the communication session 148. Through the communication session 148, user 112 and participants 144 may discuss the transaction, view and edit documents 140 associated with the transaction, and assign and complete tasks 146 associated with the transaction. The communication session 148 may allow for multiple participants 144 to communicate with user 112 to view and edit documents 140 and to assign and complete tasks 146 concurrently.

Server 110 may maintain contacts 142 associated with the transaction. User 112 may use contacts 142 to invite participants 144 to a communication session 148. Each contact 142 may correspond to one or more participants 144. A contact 142 may include a name, address, telephone number, email address, username, and/or a role associated with one or more participants 144. A contact 142 may identify one or more participants 144 to user 112. For example, if user 112 wished to communicate with an attorney and a banker in order to retitle his home for estate planning purposes, contacts 142 may include contact information for the attorney and the banker. The contact information may include the name, username, role, email address, and telephone number of the attorney and the banker. User 112 may then use the contact information to invite the attorney and the banker to a communication session 148. User 112 may also use the contact information to call, email,

Server 110 may store documents 140 associated with the transaction. User 112 and/or participants 144 may view and edit documents 140 during a communication session 148. Server 110 may apply any changes or edits made to the documents 140 and store the edited documents 140. For example, user 112 may need to change a will and a mortgage document in order to retitle his home for estate planning purposes. During a communication session 148 with an attorney and a banker, user 112 may request server 110 to retrieve the will and the mortgage document. Server 110 may access documents 140 and retrieve the will and the mortgage document so that user 112, the attorney, and the banker may view and edit these documents 140 during the communication session 148.

In particular embodiments, server 110 may associate documents 140 with a particular transaction. For example, server 110 may determine that a home purchase transaction may be associated with a purchase agreement and a loan agreement. In response to user 112 requesting a home purchase transaction, server 110 may associate a purchase agreement and a loan agreement with the requested transaction. In some embodiments, user 112 may specify documents 140 to associate with a requested transaction. For example, user 112 may specify that a mortgage insurance contract should be associated with the requested home purchase transaction. In response, server 110 may associate the mortgage insurance contract with the requested transaction. After associating these documents 140 with the requested transaction, user 112 may view and edit these documents during a communication session 148 associated with the requested transaction.

Server 110 may store tasks 146 associated with the transaction. User 112 and/or participants 144 may assign and/or complete a task 146. An assignee of the task 146 may work on and complete the task 146 asynchronously from user 112. For example, for estate planning purposes user 112 may wish to have his will redrafted. User 112 may inform the attorney to redraft the will by assigning a task 146 to the attorney. The task 146 may include the responsibility of redrafting the will. Server 110 may then assign the task 146 to the attorney. The attorney then becomes responsible for redrafting the will. The attorney may draft the will at a later time and notify server 110 when he has drafted the will. In particular embodiments, server 110 may communicate a notification to the attorney that the task 146 has been assigned to him. After the attorney finishes redrafting the will, the attorney may indicate to server 110 that the task 146 is complete. Server 110 may then designate the task 146 as complete and communicate a notification to user 112 that the task 146 of redrafting the will is complete.

In operation, user 112 may use device 114 to interact with server 110 in order to communicate with participants 144, view and edit documents 140, and assign and complete tasks 146. For example, user 112 may wish to purchase a home. User 112 may use device 114 to communicate a request 150. Request 150 may include information that identifies user 112 such as a user name and password. Request 150 may further include information that identifies the transaction requested by user 112. In the example, request 150 may identify the transaction as a home purchase transaction. Device 114 may communicate request 150 to server 110. Server 110 may receive request 150 and identify, based on request 150, the user 112 and the requested transaction. In particular embodiments, server 110 may further authenticate user 112 using the information included in request 150 such as a username and password.

Server 110 may initiate a communication session 148 so that user 112 may begin processing the transaction. Server 110 may provide contacts 142, documents 140, and tasks 146 associated with the requested transaction during the communication session 148. For example, if user 112 requests a home purchase transaction, server 110 may provide contacts 142 for an agent, a broker, and/or a lender. In addition, server 110 may provide documents 140, such as a credit report, a purchase agreement, and/or a loan agreement. Server 110 may also provide tasks 146, such as find homes for sale and find a mortgage.

In some embodiments, server 110 may initiate the communication session 148 in response to a determination that the requested transaction may be fraudulent. For example, server 110 may determine or may receive an indication that the requested transaction by user 112 may be fraudulent. Server 110 may then initiate a communication session 148 with user 112 to warn user 112 that the transaction may be fraudulent and for user 112 to communicate with particular contacts 142 in order to resolve the potentially fraudulent transaction.

In particular embodiments, server 110 may provide recommended contacts 142 to user 112. Recommended contacts 142 may correspond to participants 144 with particular levels of professional expertise. For example, server 110 may recommend a contact 142 associated with an agent that specializes in home purchases in the geographic area of interest to user 112. As another example, server 110 may provide a recommended contact 142 that corresponds to a lender who has been providing low interest rates on home mortgages. User 112 may select a contact 142 to invite a corresponding participant 144 to the communication session 148.

User 112 may use device 114 to communicate a request 152 to server 110. The request 152 may include a request type that indicates to server 110 what type of request user 112 is making. For example, the request 152 may include a request type that indicates that user 112 has selected a contact 142. The request may further include information that identifies the contact 142, such as a name and/or ID number. In response, server 110 may invite a participant 144 that corresponds to the selected contact 142 to participate in a communication session 148.

If server 110 determines that user 112 has selected a contact 142, server 110 may communicate an invitation 154 to one or more participants 144 that correspond to the selected contact 142. Participants 144 may receive the invitations on devices 114. The invitation 154 may include information associated with user 112 and the communication session 148 such as, for example, a name of user 112 and an ID associated with communication session 148. The one or more participants 144 may be associated with devices that may receive invitation 154 and present a message to the one or more participants 144 inviting them to the communication session 148. The participants 144 may then accept or reject the invitation 144. If the participants 144 accept the invitation 154, server 110 may allow participants 144 to join the communication session 148 so that participants 144 may communicate with user 112, view and edit documents 140, and assign and complete tasks 146.

As another example, the request 152 may include a request type indicating that user 112 has selected a document 140. The request 152 may include information that identifies the document 140 such as a document name and/or document ID. In response, server 110 may retrieve the selected document 140 and prepare the retrieved document 140 so that user 112 and participants 144 may view and edit the document 140. User 112 and/or participants 144 may then view and edit the document 140 during a communication session. Request 152 may include edits to the document 140. For example, user 112 may remove a paragraph from the document 140, and request 152 may instruct server 110 to delete the paragraph from the document 140.

As yet another example, the request 152 may include a request type that indicates to server 110 that user 112 has selected to assign a task 146. The request 152 may further include information about the task 146 such as an ID, a description of the task 146, the name or ID of a participant 144 or user 112 that is to be assigned the task 146 and/or a completion deadline. In response, server 110 may assign the task 146 to a designated participant 144 and/or user 112. The person to whom the task 146 is assigned then becomes responsible for completing the task. The person may work on and complete the task 146 asynchronously from the user 112. In particular embodiments, server 110 may further communicate a notification to the designated participant 144 and/or user 112 to inform him of the assigned task 146.

Server 110 may communicate a message 156 to device 114 and/or user 112. The message 156 may include information associated with communication session 148, contacts 142, documents 140, and/or tasks 146. As an example, server 110 may communicate a message 156 that indicates that a participant 144 has joined communication session 148. As another example, server 110 may communicate a message 156 that includes the name and description of a recommended contact 142. As another example, server 110 may communicate a message 156 that includes information associated with a document 140, such as the contents of the document 140. If user 112 and/or participants 144 have made edits to a document 140, message 156 may include the edits. As another example, server 110 may communicate a message 156 to indicate that a task has been assigned or has been completed. In particular embodiments, server 110 may further communicate the message 156 to one or more participants 144.

In particular embodiments, participants 144 may be assigned tasks 146. When a particular participant 144 is assigned a particular task 146, the participant 144 becomes responsible for completing that task 146. The participant may work on and complete the task at a later time. For example, if user 112 is purchasing a home, user 112 may assign the task 146 of finding a home for sale to an agent. The agent then becomes responsible for finding a home for sale. When the agent has found a home for sale, the agent may indicate to server 110 that the task 146 assigned to the agent has been completed. In response, server 110 may designate the task 146 of finding a home for sale as completed. Server 110 may then notify user 112 that the task 146 has been completed.

Server 110 may allow user 112 and one or more participants 144 to collaborate on a document 140. For example, during the purchase of a home, user 112 may need to secure a mortgage. As part of securing the mortgage, user 112 may need to complete a lender's agreement. User 112 may wish to interact with a lender and a broker in filling out a loan agreement. User 112 may use server 110 to invite a lender and a broker to a communication session 148. When the user 112, the lender, and the broker have joined communication session 148, they may discuss, view, and edit the loan agreement. In this manner, the user 112 may collaborate with other parties to draft and edit documents 140 associated with a transaction.

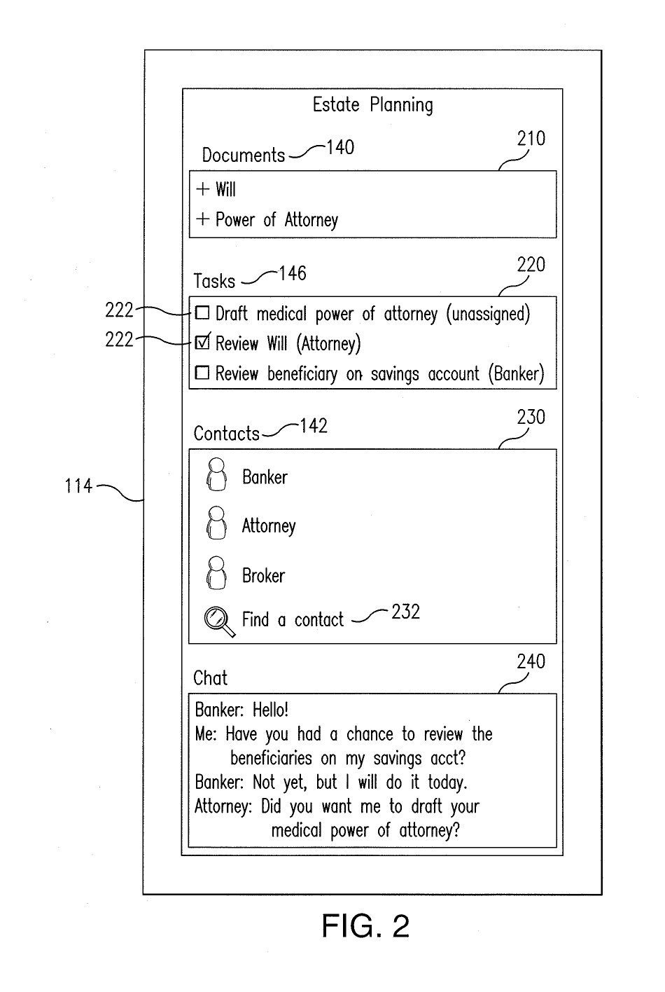

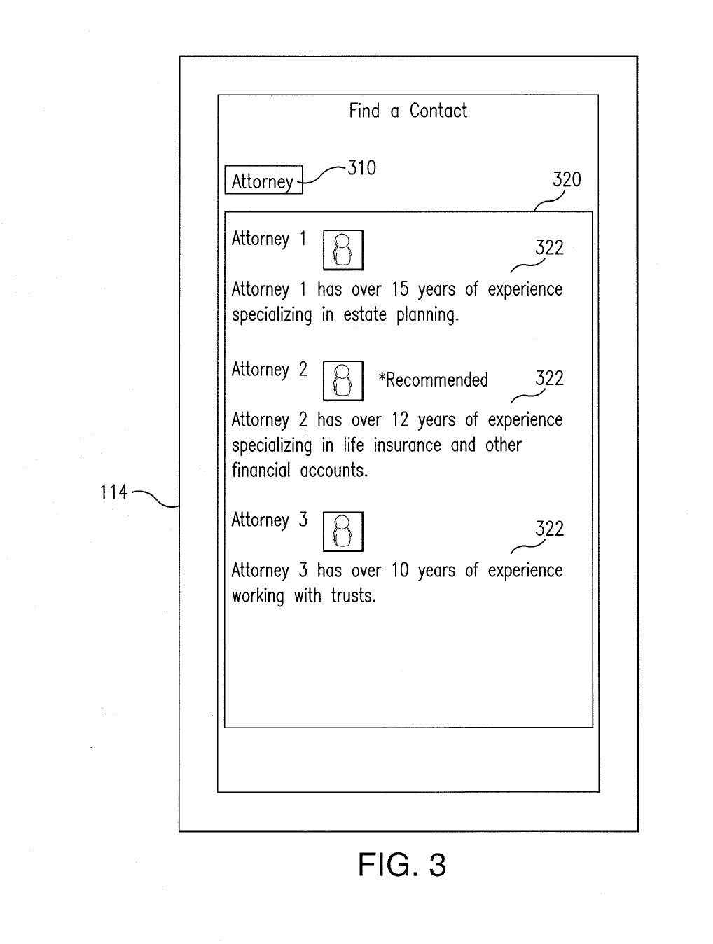

FIGS. 2 and 3 illustrate the device 114 of system 100 providing an interface through which a user 112 may asynchronously communicate with participants 144 in order to process a transaction. Various regions of a display of device 114 may be used to present documents 140, contacts 142, and tasks 146. Furthermore, a region of the display may be used to display communications between user 112 and other participants 144.

FIG. 2 illustrates a device 114 of the system 100 of FIG. 1 that aids in asynchronous communication. Device 114 may include a display on which device 114 may present an interface through which user 112 may asynchronously communicate with others. In this manner, user 112 and other participants 144 may collaborate to view and edit documents 140 and assign and complete tasks 146 in order to process a transaction.

In a first region 210 of the display, device 114 may present documents 140. User 112 may select a document 140 from the first region 210 in order to view and/or edit the document 140. The documents 140 may have been communicated to device 114 from a server 110. In the estate planning example, the first region 210 may present a will and a power of attorney. If the user 112 selects the will, device 114 may retrieve the will from the server 110 so that user 112 may view and edit the will.

In a second region 220 of the display, device 114 may present tasks 146. Device 114 may have received tasks 146 from the server 110. Each task 146 may include a description of the task 146. The description may also include the person to whom the task 146 has been assigned. In the example illustrated in FIG. 2, the first task “Draft medical power of attorney” is unassigned. The second task “Review will” has been assigned to Attorney. In particular embodiments, device 114 may initiate the creation of a new task 146. For example, user 112 may indicate on device 114 that he wishes to create a new task 146 of “Draft power of attorney.” Device 114 may then communicate a request to server 110 to create the new task 146 “Draft power of attorney.” After the new task 146 has been created, device 114 may display in the second region 220 the new task 146 “Draft power of attorney” with an “unassigned” indicator. User 112 may then assign the new task 146 to the attorney. Device 114 may then indicate that the new task 146 is assigned to the attorney. After the attorney completes drafting the power of attorney, he may indicate to server 110 that the task 146 is complete. Device 114 may then update the task 146 to indicate that the task 146 is complete.

Device 114 may further present in the second region 220, indicators 222 associated with tasks 146. Indicators 222 may show whether tasks 146 are completed or not. In the example, the task 146 “Draft medical power of attorney” has an empty box next to it indicating that the task 146 of drafting the medical power of attorney is incomplete. The task 146 “Review will” has a checked box next to it indicating that the task 146 of reviewing the will is complete. Although this disclosure describes a particular type of indicator 222, this disclosure contemplates any suitable type of indicator 222 that indicates that a task 146 is complete or incomplete.

In a third region 230 of the display, device 114 may present contacts 142. Device 114 may have received contacts 142 from the server 110. A contact 142 may be associated with one or more participants 144. In the example illustrated in FIG. 2, contacts 142 may be associated with a banker, an attorney, and a broker. User 112 may select a contact 142 on device 114 to initiate communications with the participant 144 associated with the selected contact 142. For example, user 112 may select the contact 142 associated with the banker to begin chatting with the banker. As another example, user 112 may select the contact 142 associated with the attorney to write an email to the attorney.

Device 114 may further present in the third region 230 an option 232 to find a contact 142. If user 112 selects the option 232, device 114 may provide an interface through which user 112 may search for a contact 142. For example, if user 112 wishes to search for a lender who is currently not listed in the list of contacts 142, user 112 may select the option 232 to find the lender. In particular embodiments, device 114 may present in the interface recommended contacts 142. The searching for a contact function will be discussed further with respect to FIG. 3.

In a fourth region 240 of the display, device 114 may present communications between user 112 and participants 144. In the example illustrated in FIG. 2, the fourth region 240 of the display includes a chat amongst the user 112, the banker, and the attorney. The user 112, the banker, and the attorney are discussing the statuses of incomplete tasks 146 such as reviewing the beneficiaries on the user's 112 savings account and drafting the medical power of attorney. In response to the attorney's question of whether he should draft the medical power of attorney, the user 112 may assign the task 146 of drafting the medical power of attorney to the attorney. The description of the task 146 in the second region 220 may then be updated to show that the task 146 of drafting the medical power of attorney has been assigned to the attorney. In this manner, the user 112 may collaborate with other participants 144 to complete tasks 146. Although this disclosure illustrates the communication occurring in text form, this disclosure contemplates the communication occurring in any suitable form such as for example audio and/or video. For example, device 114 may present, in the fourth region 240, video of the user 112, banker, and attorney.

FIG. 3 illustrates a device 114 of the system 100 of FIG. 1 that aids in asynchronous communication. User 112 may use device 114 to search for contacts 142 that may help process the requested transaction.

In a fifth region 310 of the display, device 114 may present a search field. User 112 may input text into the search field to initiate a search for a contact 142. For example, user 112 may input the name of a contact to initiate a search for that name. As another example, user 112 may input a role or a position such as attorney to initiate a search for contacts 142 who hold that role or position. In the example illustrated in FIG. 3, the user 112 has inputted the role of attorney into the search field. Device 114 may communicate the search to a server 110. In response, the server 110 may search for contacts 142 that meet the search criteria inputted into the search field. Server 110 may then return the results to device 114, such as in a message 156.

In a sixth region 320 of the display, device 114 may present the search results 322. Each search result 322 may include a name, a portrait, and a description associated with the search result. User 112 may select a particular search result 322 to add the contact 142 associated with that search result 322 to his list of contacts 142. In the example illustrated in FIG. 3, the user's 112 search for “Attorney” has returned three search results 322 for Attorney 1, Attorney 2, and Attorney 3. The descriptions for each search result 322 indicate the experience of the particular attorney. By using the descriptions, user 112 may locate an attorney who is best suited for the user's 112 transaction. If user 112 selects Attorney 3, then the contact 142 associated with Attorney 3 will be added to the user's 112 list of contacts 142.

In particular embodiments, server 110 may return a recommended contact 142. The recommended contact 142 may be a contact 142 that has been preferred by other users 112, has demonstrated exceptional performance previously, and/or any other suitable reason. Device 114 may present the credentials of the recommended contact 142. For example, device 114 may describe the experience of the recommended contact 142 and/or the past performance of the recommended contact 142. Device 114 may present an indicator that shows that a particular search result 322 is for a recommended contact 142. In the illustrated example of FIG. 3, device 114 presents an asterisk and the word “Recommended” next to the portrait associated with a recommended contact in order to show that the contact 142 is a recommended contact 142.

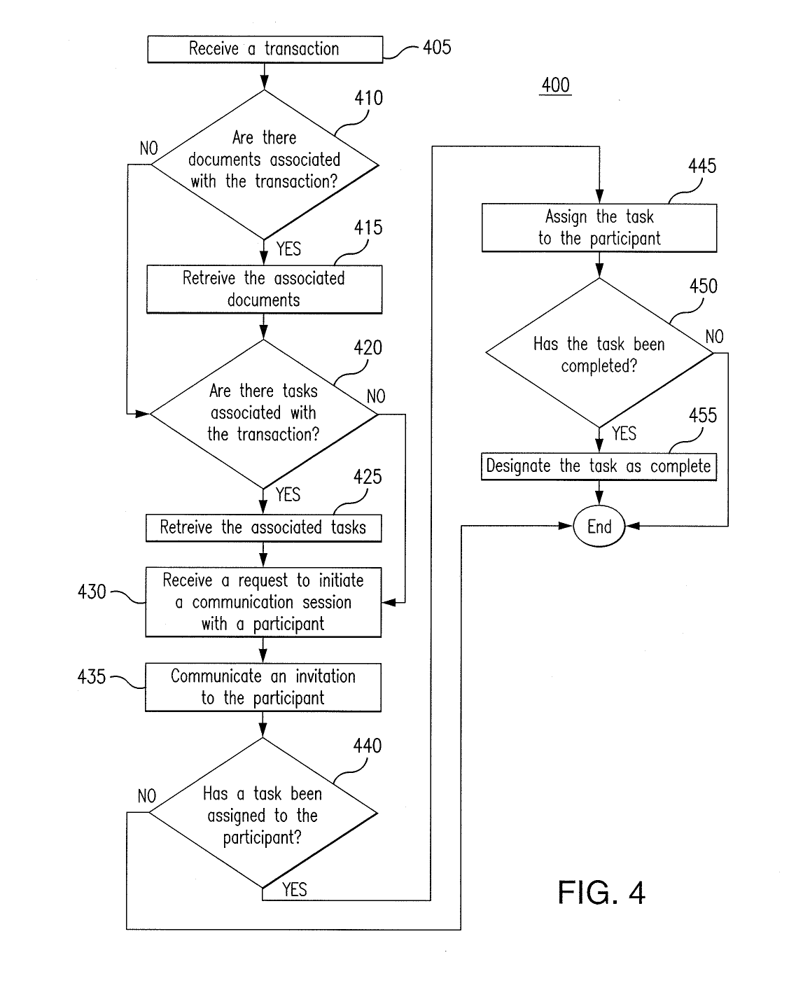

FIG. 4 is a flowchart illustrating a method 400 of asynchronous communication. Server 110 may perform method 400. In particular embodiments, by performing method 400 server 110 may allow user 112 to collaborate with other participants 144 to quickly process transactions.

In step 405, server 110 may receive a transaction. The transaction may have been communicated by user 112 using device 114. For example, user 112 may have communicated that he wishes to purchase a home. Server 110 may receive the transaction and determine that user 112 wishes to purchase a home.

In step 410, server 110 may determine if there are documents associated with the transaction. The documents may be default documents associated with the requested transaction or they may be documents that the user 112 has previously associated with the transaction. For example, server 110 may determine that a loan agreement is associated with a home purchase transaction. If the server 110 determines that there are no documents associated with the transaction, server 110 may continue to step 420. If server determines that there are documents associated with the transaction, then server 110 may retrieve the associated documents in step 415.

Server 110 may determine if there are tasks associated with the transaction in step 420. The tasks may have been assigned to user 112 and/or a participant 144. The tasks may be complete or incomplete. The person to whom the task is assigned is responsible for completing the task. If the server 110 determines that there are no tasks associated with the transaction, server 110 may continue to step 430. If server 110 determines that there are tasks associated with the transaction, server 110 may retrieve the associated tasks in step 425.

In step 430, the server 110 may receive a request to initiate a communication session with the participant. The communication session may allow the user 112 and the participant 144 to discuss the transaction, view and edit documents, and assign and complete tasks. Server 110 may communicate an invitation to the participant to join the communication session in step 435. The participant may accept or decline the invitation. If the participant accepts, server 110 may place the participant in the communication session. If the participant declines, server 110 may communicate a message to the user 112 that the participant has declined the invitation.

In step 440, server 110 may determine if a task has been assigned to the participant. User 112 and/or the participant may have communicated a message to the server 110 to indicate that the task has been assigned to the participant. If no such message is received, the task may remain unassigned. If the task has not been assigned to the participant, server 110 may conclude. If the task has been assigned to the participant, server 110 may continue to step 445 to assign the task to the participant. For example, if user 112 communicates a message to indicate that the task of drafting a will has been assigned to an attorney, then server 110 may assign the task of drafting the will to the attorney.

Server 110 may determine whether the task has been completed. In particular embodiments, user 112 and/or the participant may communicate a message to indicate that a particular task has been completed. If server 110 receives the message, server 110 may designate the task as completed in step 455. If no such message is received, server 110 may conclude.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An apparatus comprising:
a memory operable to:
store a document associated with a user;
a processor communicatively coupled to the memory and operable to:
receive a transaction associated with the user;
associate the document with the transaction;
initiate, between the user and a participant, a communication session associated with the transaction; and
assign a task to the participant so that the participant is responsible for performing the task in order for the transaction to be resolved.

2. The apparatus of claim 1, wherein the processor is further operable to communicate an invitation to the participant in order to invite the participant to the communication session.

3. The apparatus of claim 1, wherein the user is authenticated prior to the receipt of the transaction.

4. The apparatus of claim 1, wherein the communication session is initiated based at least in part upon a risk that the transaction is fraudulent.

5. The apparatus of claim 1, wherein the processor is further operable to designate the task as complete in response to receiving a message indicating that the task is complete.

6. The apparatus of claim 1, wherein the document is associated with estate planning.

7. The apparatus of claim 1, wherein the processor is further operable to communicate, to the user and the participant, edits to the document.

8. One or more computer-readable non-transitory storage media embodying software that is operable when executed to:
present, on a display, a transaction associated with a user;
present, on the display, a document associated with the transaction;
present, on the display, a plurality of contacts;
communicate a request to invite a contact from the plurality of contacts to participate in a communication session;
initiate the creation of a task associated with the transaction; and
communicate a request to assign the task to the contact so that the contact is responsible for performing the task in order for the transaction to be resolved.

9. The media of claim 8, wherein the conversation occurs through at least one of text and video.

10. The media of claim 8 embodying software that is further operable when executed to receive a request to join a second communication session.

11. The media of claim 8 embodying software that is further operable when executed to present, on the display, an indication that the task is complete.

12. The media of claim 8 embodying software that is further operable when executed to present, on the display, a recommended contact from the plurality of contacts and the credentials of the recommended contact.

13. The media of claim 8 embodying software that is further operable when executed to mark the task as complete in response to receiving a message indicating that the task is complete.

14. A method comprising:
storing, by a memory, a document associated with a user;
receiving a transaction associated with the user;
associating, by a processor, the document with the transaction;
initiating, by the processor, between the user and a participant, a communication session associated with the transaction; and
assigning, by the processor, a task to the participant so that the participant is responsible for performing the task in order for the transaction to be resolved.

15. The method of claim 14, further comprising communicating, by the processor, an invitation to the participant in order to invite the participant to the communication session.

16. The method of claim 14, wherein the user is authenticated prior to the receipt of the transaction.

17. The method of claim 14, wherein the communication session is initiated based at least in part upon a risk that the transaction is fraudulent.

18. The method of claim 14, further comprising designating, by the processor, the task as complete in response to receiving a message indicating that the task is complete.

19. The method of claim 14, wherein the document is associated with estate planning.

20. The method of claim 14, further comprising communicating, by the processor, to the user and the participant, edits to the document.

21. The method of claim 14, further comprising communicating, by the processor, a recommended contact and the credentials of the recommended contact.
